(19) United States
(12) Patent Application Publication
(10) Pub. No.: US 2013/0247190 A1
(43) Pub. Date: Sep. 19, 2013

(54) SYSTEM, METHOD, AND COMPUTER PROGRAM PRODUCT FOR UTILIZING A DATA STRUCTURE INCLUDING EVENT RELATIONSHIPS TO DETECT UNWANTED ACTIVITY

(71) Applicant: Joel R. Spurlock, Newberg, OR (US)

(72) Inventor: Joel R. Spurlock, Newberg, OR (US)

(21) Appl. No.: 12/177,601

(22) Filed: Jul. 22, 2008

(51) Int. Cl. G06F 21/00

(52) U.S. Cl. 726/23

(57) ABSTRACT

A system, method, and computer program product are provided for utilizing a data structure including event relationships to detect unwanted activity. In use, a plurality of events is identified. Additionally, a data structure including objects associated with the plurality of events and relationships associated with the plurality of events is generated. Further, unwanted activity is detected utilizing the data structure.

### FIELD OF THE INVENTION

The present invention relates to detecting unwanted activity, and more particularly to detecting unwanted activity based on identified events.

### BACKGROUND

Security systems have traditionally been utilized for detecting unwanted activity. Such unwanted activity has oftentimes included activity of malware. However, traditional security systems have generally exhibited various limitations in employing techniques for detecting unwanted activity based on events. Just by way of example, techniques conventionally utilized to detect unwanted activity based on events have been incapable of detecting unwanted activity spanning multiple events and/or associated objects (e.g. processes, etc.).

There is thus a need for addressing these and/or other issues associated with the prior art.

### SUMMARY

A system, method, and computer program product are provided for utilizing a data structure including event relationships to detect unwanted activity. In use, a plurality of events is identified. Additionally, a data structure including objects associated with the plurality of events and relationships associated with the plurality of events is generated. Further, unwanted activity is detected utilizing the data structure.

### DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for utilizing a data structure including event relationships to detect unwanted activity, in accordance with one embodiment.

FIG. 4 shows a system for utilizing a data structure including event relationships to detect unwanted activity, in accordance with another embodiment.

FIG. 5 shows a method for generating a data structure including event relationships, in accordance with yet another embodiment.

FIG. 6 shows a state transition diagram for identifying objects of interest to be included in a data structure, in accordance with still yet another embodiment.

### DETAILED DESCRIPTION

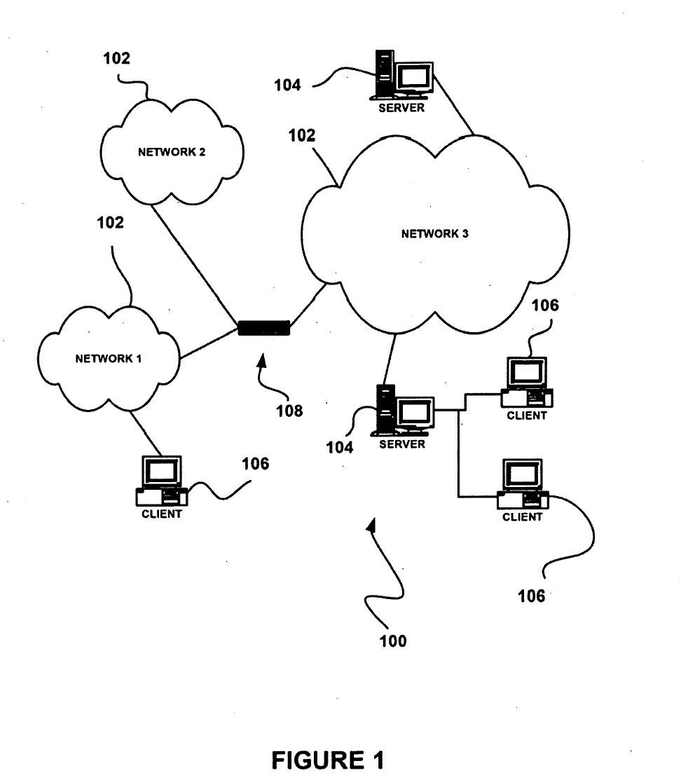

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

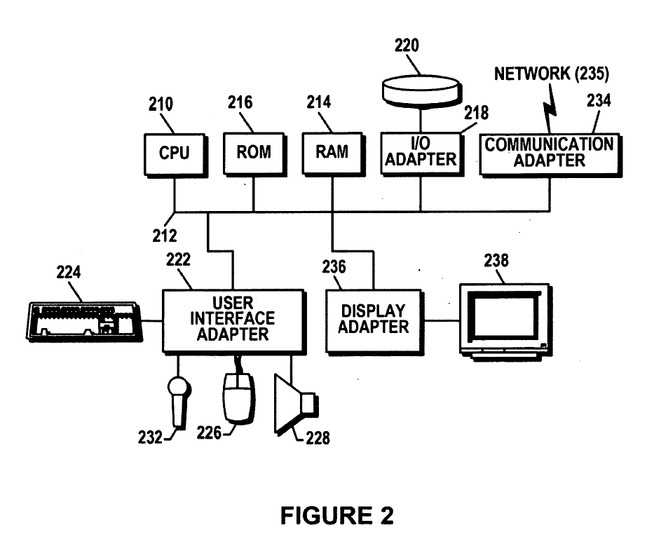

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

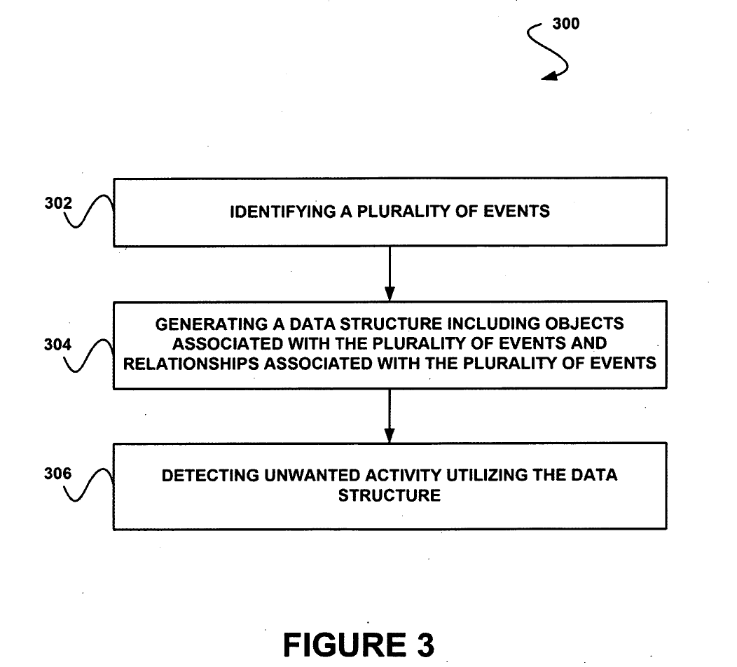

FIG. 3 shows a method 300 for utilizing a data structure including event relationships to detect unwanted activity, in accordance with one embodiment. As an option, the method 300 may be carried out in the context of the architecture and environment of FIGS. 1 and/or 2. Of course, however, the method 300 may be carried out in any desired environment.

As shown in operation 302, a plurality of events is identified. In the context of the present description, the events may include any activities performed on a device. As an option, the device may include any of the devices described above with respect to FIGS. 1 and/or 2. Further, the events may include activities, such that identifying the events may include detecting the activities. For example, the activities may be detected as being indicative of an unwanted behavior pattern. Thus, in various embodiments, the events (e.g. activities) may optionally include writing to file, a first process modifying memory in a second process, creating a registry key, etc.

Additionally, the events may include events predetermined to be of interest. In one embodiment, the events predetermined to be of interest may include events originating from at least one predetermined source. Such predetermined source may include a source predetermined to at least potentially be associated with unwanted activity (e.g. malware, etc.). Thus, the predetermined source may be dynamic.

As an option, the predetermined source may include a plurality of predetermined activities (e.g. a predetermined sequence of activities, etc.). As another option, the predetermined source may include any source external to the device on which the events are identified. Just by way of example, the predetermined source may include an attachment received in an electronic mail message, a web browser that executes a downloaded file, data communicated over a network, etc.

In another embodiment, the events predetermined to be of interest may be events that include predetermined activity. The events may optionally be derived from a single activity, a combination of activities, etc. In various exemplary embodiments, the events may include termination of a security application (e.g. an anti-virus application, intrusion prevention system, etc.), writing data to an executable associated with the security application, reading Internet cache, sending electronic mail [e.g. simple mail transfer protocol (SMTP) mail], opening a network port, etc.

Further, the events may be identified in any desired manner. In one embodiment, the events may be identified by monitoring a superset of events performed utilizing the device. For example, all events of the device may be monitored for identifying events of interest. As another example, all of the events may be compared to predetermined events of interest for identifying the events of interest.

Also, as shown in operation 304, a data structure including objects associated with the events and relationships associated with the events is generated. With respect to the present description, the data structure may include any type of data structure capable of storing objects associated with the events and relationship associated with the events. Just by way of example, the data structure may include a hierarchical data structure (e.g. hierarchical tree, etc.).

In addition, the objects associated with the events may include any objects accessed, created, modified, etc. via the events. For example, the objects may include objects stored on the device. In various embodiments, the objects may include a network connection, a process, a thread, a file, a registry key, etc. In one embodiment, the objects may be included in the data structure in response to the identification of an associated one of the events.

Further, the relationships associated with the events may include relationships between the events and the objects. As an option, each of the relationships may indicate an action (e.g. activity) performed with respect to one of the objects via one of the events. For example, one of the relationships may indicate that one of the objects was created by one of the events, etc.

As an option, a state of each of the objects may also be stored in the data structure. Such state may include suspicious (e.g. potentially associated with unwanted activity), innocent (e.g. not associated with unwanted activity), detected (e.g. known to be associated with unwanted activity), etc. For example, successive states of each of the objects may be stored in the data structure. As another option, only objects with a suspicious state may be stored in the data structure. Of course, however, the data structure may include any desired type of information associated with the events, such as event type, an originating location (e.g. device, application, etc.), a state of the originating location, a target location (e.g. a location targeted by the event), event parameters, etc.

In one embodiment, the data structure may be generated in response to identification of a first one of the events. The first one of the events may include the event that was identified first, for example. Thus, in response to identification of the first one of the events, any objects and relationships associated with the first event may be stored in the data structure. Further, as each subsequent one of the events is identified, objects and relationships associated with such subsequent events may be stored in the data structure. To this end, the data structure may optionally indicate a history of events associated with each of the objects.

In another embodiment, the data structure may be generated by storing objects in the data structure based on the relationship with the associated event. For example, as an event is identified, an object associated with the event may be stored in the data structure as a node to another object stored in the data structure. Such other object may include an object from which the event originated, for example, but of course may include any other object that is associated with the identified event.

Still yet, as shown in operation 306, unwanted activity is detected utilizing the data structure. In the context of the present description, the unwanted activity may include any activity that is determined to be unwanted. For example, the unwanted activity may include malware (e.g. a virus, etc.).

In one embodiment, the unwanted activity may be detected by performing a behavioral analysis of the data structure. As noted above, the data structure may optionally indicate a history of events associated with each of the objects. Thus, the history of events for each object may optionally be utilized to determine whether unwanted activity is associated with each object. For example, the behavioral analysis may be performed with respect to the history of events for each object for detecting unwanted activity associated with such object.

In another embodiment, the unwanted activity may be detected by scanning the data structure. Of course, it should be noted that the unwanted activity may be identified in any manner that utilizes the data structure. In this way, unwanted activity spanning a plurality of events associated with an object and/or a plurality of events associated with a plurality of different objects may be detected, utilizing the data structure.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

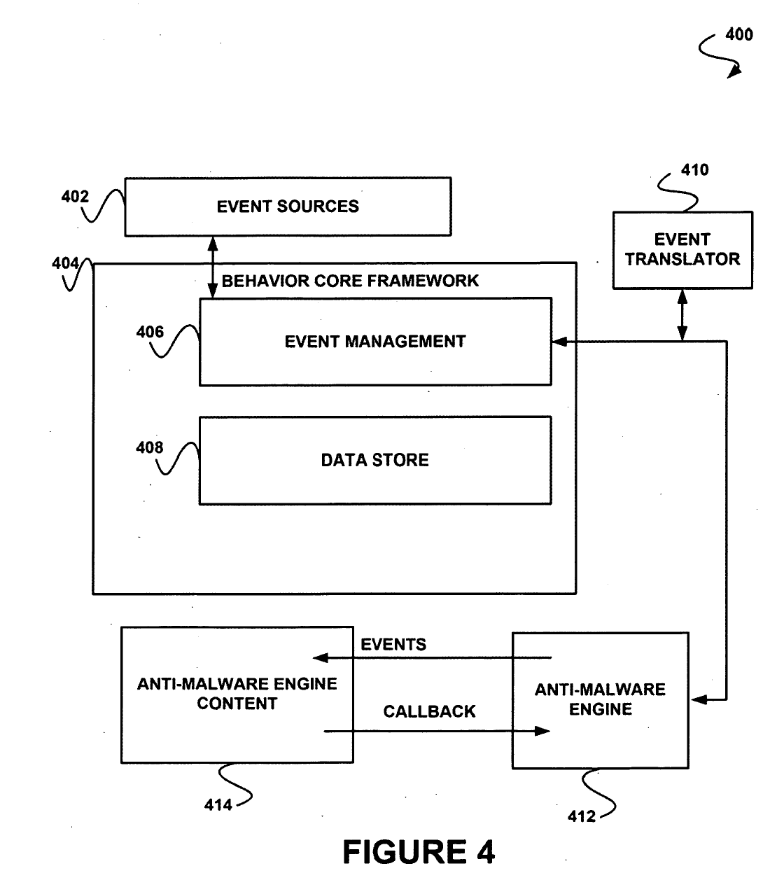

FIG. 4 shows a system 400 for utilizing a data structure including event relationships to detect unwanted activity, in accordance with another embodiment. As an option, the system 400 may be implemented in the context of the architecture and environment of FIGS. 1-3. Of course, however, the system 400 may be implemented in any desired environment. It should also be noted that the aforementioned definitions may apply during the present description.

As shown, an event management module 406 of a behavior core framework 404 is in communication with event sources 402. The event sources 402 may include any number of different sources capable identifying events. Such events may include events performed utilizing a device on which the behavior core framework 404 is installed, for example.

For example, the event sources 402 may include system sources or external sources (e.g. network resources, etc.). In various embodiments, the event sources 402 may include filter drivers, hooks, applications, log files, system calls, etc. As an option, the event sources 402 may identify the events by monitoring events performed utilizing the device. As another option, the event sources 402 may identify the events by intercepting events performed utilizing the device.

In response to identification of the events, the event sources 402 transmit the events to the event management module 406 of the behavior core framework 404. Accordingly, the behavior core framework 404 may optionally include a platform for receiving events from a plurality of different sources included in the event sources 402. As an option, each of the sources may provide the events to the behavior core framework 404 in a different format. To this end, the behavior core framework 404 may be capable of receiving and managing events in various different formats.

In response to receipt of the events by the event management module 406 of the behavior core framework 404, such event management module 406 may manage the received events. In one embodiment, the event management module 406 may analyze the events for identifying a subset of the events that are of interest. Optionally, the event management module 406 may identify the events of interest by comparing a source of each of the events to predetermined sources of interest and/or by comparing an activity associated with the events to predetermined activities of interest.

In this way, if a source of the event matches a predetermined source and/or an activity associated with the event matches a predetermined activity, the event may be determined by the event management module 406 to be an event of interest. In one embodiment, the predetermined sources of interest and/or the predetermined activities of interest may be defined by an anti-malware engine 412. Such anti-malware engine 412 may include a security system for processing the events of interest, as described in more detail below. In another embodiment, the predetermined sources of interest and/or the predetermined activities of interest may be defined by an anti-malware engine content module 414 utilized by the anti-malware engine 412.

Events received by the behavior core framework 404 may further be filtered by the event management module 406, such that only the events of interest are transmitted to an event translator 410. The event translator 410 may include any module (e.g. installed on the device) capable of normalizing the events of interest. For example, the event translator 410 may normalize the events of interest into a single format. Such format may include any format capable of being read by the anti-malware engine 412. In this way, the anti-malware engine 412 may be capable of detecting unwanted activity independent of a format of the events as received from the event sources 402, as described in further detail below.

As an option, the event translator 410 may communicate with the data store 408. For example, the event translator 410 may include an interface to the data store 408. The data store 408 may store objects associated with the events of interest and relationships associated with the events of interest. In one embodiment, the event translator 410 may extract information from the events of interest (e.g. events from the event sources 402), including information in the event and the objects and relationships associated with the events of interest, and store such information in the data store 408.

Of course, however, the event translator 410 may also extract any other information from the events of interest for storage in the data store 410, such as an identifier for each of the events, an identifier of an object from which the event originated, a name of the object from which the event originated, a state of the object from which the event originated, an identifier of an object targeted by the event, a name of the object targeted by the event, a state of the object targeted by the event, parameters of the event, hashes and/or other signatures [e.g. Message-Digest algorithm 5 (MD5), Secure Hash Algorithm 1. (SHA1), etc.], etc. While not shown, it should be noted that the event translator 410 may be included in the behavior core framework 404.

Further, the event translator 410 transmits the events of interest to the anti-malware engine 412. In response to receipt of the events of interest, the anti-malware engine 412 forwards the events of interest to the anti-malware engine content module 414. To this end, the anti-malware engine content module 414 may generate a data structure including the objects associated with the events of interest and the relationships associated with the events for interest.

In one embodiment, the data structure may be stored in the anti-malware engine content module 414. As an option, the anti-malware engine content module 414 may retrieve the objects associated with the events of interest and the relationships associated with the events of interest from the data store 408 based on the receipt of the events of interest. For example, the anti-malware engine content module 414 may utilize callbacks directed to the anti-malware engine 412 for retrieving the objects associated with the events of interest and the relationships associated with the events of interest from the data store 408 via the anti-malware engine 412 and optionally via the event translator 410. Thus, just by way of example, the anti-malware engine content module 414 may store objects and relationships associated with an event of interest in the data structure upon receipt of such event of interest.

As another option, the data structure may only maintain some objects and associated relationships stored therein during a reboot of the device. Just by way of example, files and registry keys may persist in the data structure during the reboot. As another example, processes may be removed from the data structure upon the reboot since such processes may be terminated upon the reboot. Thus, the data structure may optionally track objects throughout any number of device reboots.

Still yet, anti-malware engine content module 414 may communicate a request to the anti-malware engine 412 to analyze the data structure for detecting unwanted activity. In one optional embodiment, the anti-malware engine content module 414 may include a trigger for determining whether a threshold amount of objects and relationships associated with events of interest is stored in the data structure. If the threshold is met, the anti-malware engine content module 414 may send the detection request to the anti-malware engine 412.

Moreover, in response to receipt of a request to detect unwanted activity by the anti-malware engine 412, the anti-malware engine 412 may determine whether the data structure indicates that unwanted activity is associated with any of the objects stored therein. In one embodiment, the anti-malware engine 412 may perform a behavioral analysis of the data stored in the data structure for detecting the unwanted activity. In another embodiment, the anti-malware engine 412 may compare the data stored in the data structure to logic, patterns, rules, etc. for detecting the unwanted activity. In yet another embodiment, the anti-malware engine 412 may extract information of interest from the event sources 402 or the objects themselves (e.g. for detecting the unwanted activity).

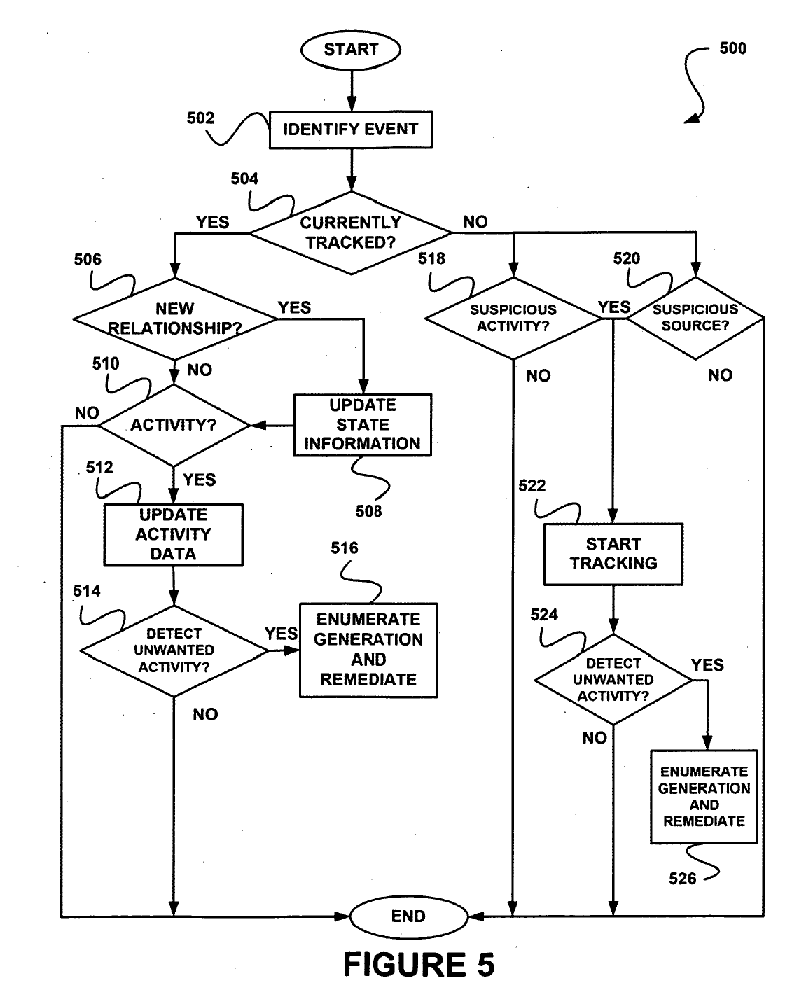

FIG. 5 shows a method 500 for generating a data structure including event relationships, in accordance with yet another embodiment. As an option, the method 500 may be carried out in the context of the architecture and environment of FIGS. 1-4. Of course, however, the method 500 may be carried out in any desired environment. Again, it should be noted that the aforementioned definitions may apply during the present description.

As shown in operation 502, an event is identified. The event may be identified by monitoring events performed on a device. For example, the event may be identified utilizing the event sources 402 of FIG. 4.

Additionally, it is determined whether the event is currently tracked, as shown in decision 504. In the context of the present embodiment, the event may be currently tracked if information associated with the event is already stored in a data structure. For example, the event may be currently tracked if any objects and relationships associated with the event are stored in the data structure.

In one embodiment, the data structure may be queried for the object from which the event originated or the object targeted by the event for determining whether the event is currently being tracked. As an option, the determination of whether the event is currently tracked may be based on a state of an object associated with the event, such as whether the state of the object is suspicious.

If it is determined that the event is not currently tracked, it is determined in parallel whether the event includes suspicious activity (decision 518) and whether the event originated from a suspicious source (decision 520). The suspicious activity may include any activity predetermined to at least potentially include unwanted activity, in one embodiment. In another embodiment, the suspicious source may include any source predetermined to at least potentially be associated with unwanted activity.

As an option, it may be determined that the event includes suspicious activity if activity of the event does not match activity predetermined to be unsuspicious. As another option, it may be determined that the event originated from a suspicious source if the source of the event does not match any sources predetermined to be unsuspicious. For example, the activity predetermined to be unsuspicious and the sources predetermined to be unsuspicious may each be stored in separate whitelists. As still yet another option, the activity may be determined to be suspicious based on the objects (e.g. via analysis of file bytes to determine whether it contains an simple mail transfer protocol (SMTP) engine, to determine whether it is packed in a suspicious manner, etc.).

If it is determined that the event does not include suspicious activity (decision 518) and that the event did not originate from a suspicious source (decision 520), the method 500 is terminated. For example, it may be determined that the event is not of interest. In this way, performance optimization associated with analysis of events may be achieved by preventing storage of events that are not interest in the data structure, such that when detection of unwanted activity utilizing the data structure is performed an attempt to detect unwanted activity utilizing events not of interest is avoided.

If, however, it is determined that the event includes suspicious activity (decision 518) or that the event originated from a suspicious source (decision 520), tracking of the event is started. Note operation 522. The tracking of the event may include storing in the data structure objects associated with the event and relationships associated with the event. As another option, the tracking of the event may include generating a data structure for storing objects associated with the event and relationships associated with the event.

Further, as shown in decision 524, it is determined whether unwanted activity is detected. For example, a generation (e.g. of a sample) that is based on events and/or state transitions may be detected. With respect to the present embodiment, the data structure via which the event is tracked may be utilized for determining whether the unwanted activity is detected. In one embodiment, a behavioral analysis may be performed on the data stored in the data structure for detecting the unwanted activity. As an option, the unwanted activity may be detected based on a single activity, a history of activities and states in a generation associated with the tracking of the events, or optionally by an analysis of the generation.

If it is determined that unwanted activity is not detected, the method 500 terminates. If, however, it is determined that unwanted activity is detected, the generation of the data structure is enumerated and remediation is performed. Note operation 526. Enumerating the generation of the data structure may include traversing each object in the data structure according to the relationships of such objects stored in the data structure.

As an object is traversed, remediation of the unwanted activity may be performed by reversing a state of such object that resulted from the associated event. For example, if the event includes creating the object, the remediate may include deleting the object. As another example, if the event includes modifying the object, the remediation may include removing the modifications made to the object. As yet another example, if the event includes deleting the object, the remediation may include restoring the object. In this way, effect of detected unwanted activity may be repaired utilizing the data structure.

If, in decision 504 it is determined that the event is currently tracked, it is further determined whether a relationship associated with the event is new. Note decision 506. For example, it may be determined whether an activity performed with respect to an object associated with the event is already stored in the data structure. If it is determined that the relationship associated with the event is new, state information is updated, as shown in operation 508.

The state information may be updated by storing such state information in the data structure. Further, the state information may include any state of an object associated with the event. For example, the state information may indicate whether the object is created, modified, deleted, etc. via the event. As another example, the state information may reflect the new relationship associated with the event.

If it is determined that the relationship associated with the event is not new (decision 506), or in response to the update to the state information (operation 508), it is determined whether the event includes a suspicious activity. Note decision 510. Accordingly, activity may be detected. If the event does not include a suspicious activity, the method 500 terminates. If, however, the event does include a suspicious activity, activity data is updated. Note operation 512. The activity data may be updated by storing information associated with the suspicious activity in the data structure.

Further still, it is determined whether unwanted activity is detected, as shown in decision 514. For example, a generation (e.g. of a sample) that is based on events and/or state transitions may be detected. As noted above, the data structure via which the event is tracked may be utilized for determining whether the unwanted activity is detected. For example, the behavioral analysis may be performed on the data stored in the data structure for detecting the unwanted activity.

If it is determined that unwanted activity is not detected, the method 500 terminates. If, however, it is determined that unwanted activity is detected, the generation of the data structure is enumerated and remediation is performed. Note operation 516. For example, the enumeration and remediation may be performed in the manner described above with respect to operation 526. In this way, effect of detected unwanted activity may be repaired utilizing the data structure.

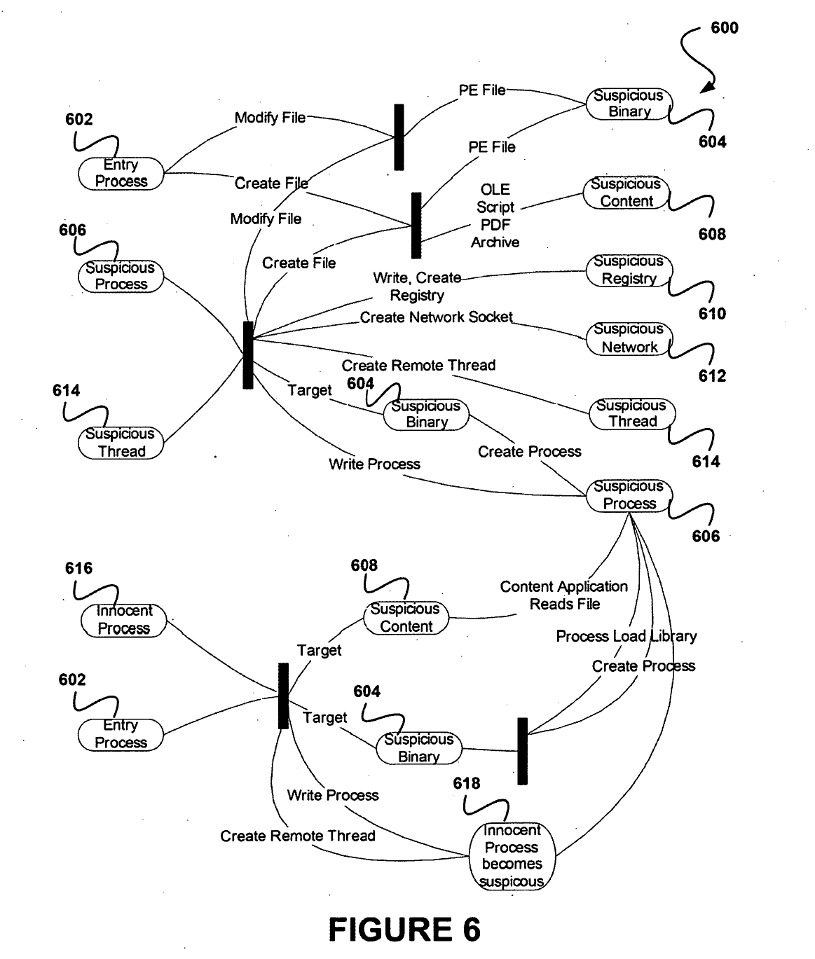

As an option, the method 500 may include a check for relationships between events and activity before the method 500 terminates. For example, the check for relationships may performed as described below with respect to FIG. 6. Such check may be performed in parallel with the present method 500.

FIG. 6 shows a state transition diagram 600 in which objects of interest are identified for inclusion in a data structure, in accordance with still yet another embodiment. As an option, the state transition diagram 600 may be implemented in the context of the architecture and environment of FIGS. 1-5. Of course, however, the state transition diagram 600 may be implemented in any desired environment. Yet again, it should be noted that the aforementioned definitions may apply during the present description.

It should be noted that the state transitions shown herein are set forth for illustrative purposes only, and that any state transitions may be utilized for identifying objects of interest. For example, the state transitions (e.g. of an anti-malware engine content module and/or an anti-malware engine) indicative of objects of interest may be updated as desired.

As shown, an entry process 602 may modify and/or create a portable executable file. In the context of the present embodiment, the portable executable file may be predetermined to be a suspicious binary 604, as also shown. Accordingly, when the entry process 602 targets the suspicious binary 604 (e.g. via the modification and/or creation thereof), the entry process 602 may be identified as a suspicious process 606, and may therefore be stored in a data structure utilized for detecting unwanted activity. As an option, storing the suspicious process 606 in the data structure may include storing an identifier of the suspicious process 606 and a relationship of the suspicious process 606 with the suspicious binary 604.

As also shown, the suspicious process 606 may modify and/or create the portable executable file which is predetermined to be the suspicious binary 604. The suspicious process 606 may include a source predetermined to be suspicious (e.g. based on the modification and/or creation of the portable executable file described above). Thus, since the suspicious process 606 is a suspicious source performing the event (e.g. the modification or creation of the portable executable file) associated with the suspicious binary 604, the suspicious process 606 may be stored in the data structure.

Similarly, the suspicious process 606 may create an object linking and embedding (OLE) script in a portable document format (PDF) archive. As noted above, the suspicious process 606 may include a source predetermined to be suspicious. Thus, the OLE script may be determined to include suspicious content 608 based on the creation by the suspicious process 606, such that the event (e.g. the creation of the OLE script in the PDF archive) associated with the suspicious content 608 may be stored in the data structure.

In addition, the suspicious process 606 may write to and/or create a registry, create a network socket, create a remote thread and/or write to a process. Again, since such events are performed by the suspicious process 606, the registry may be determined to be a suspicious registry 610, the network socket may be determined to be a suspicious network socket 612, the remote thread may be determined to be a suspicious thread 614 and/or the write process may be determined to be a suspicious process 606. To this end, the events associated with the suspicious registry 610, the suspicious network socket 612 and/or the suspicious thread 614 may be stored in the data structure.

Moreover, the suspicious process 606 may also target the suspicious binary 604, to create a process, thus resulting in a suspicious process 606. Accordingly, the event associated with the suspicious process. 606 (e.g. the creation of the process by the suspicious binary 604) may be stored in the data structure. Similarly, the suspicious thread 614 may also perform the events described above with respect to the suspicious process 606, such that the events may be stored in the data structure.

Still yet, an innocent process 616 and/or the entry process 602 may target a suspicious binary 604 to execute a load library process and/or to create a process, thus resulting in a suspicious process 606. Such events may therefore be stored in the data structure. Additionally, the innocent process 616 and/or the entry process 602 may target suspicious content 608 to read a file utilizing a content application, thereby resulting in a suspicious process. The reading of the file event may be stored in the data structure since the target of the event (the suspicious content 608) is suspicious.

However, if the innocent process 616 writes a process and/or creates a remote thread, the innocent process 616 may become a suspicious process 606 (see 618). To this end, an event (e.g. the objects associated with the event and the relationships associated with the event) may be stored in a data structure if the source of the event and/or the target of the event are suspicious.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer program product embodied on a tangible non-transitory computer readable medium for performing operations, comprising:
identifying a plurality of events;
generating a data structure including objects associated with the plurality of events; and
detecting unwanted activity utilizing the data structure, wherein the plurality of events includes events predetermined to be of interest, which includes termination of a security application, and events originating from a predetermined source associated with unwanted activity.

2. The computer program product of claim 1, wherein the plurality of events includes activities performed on a device.

3. The computer program product of claim 1, wherein the plurality of events include writing to a file.

4. The computer program product of claim 1, wherein the plurality of events include a first process modifying memory in a second process.

5. (canceled)

6. (canceled)

7. The computer program product of claim 1, the operations further comprising monitoring a superset of events performed utilizing a device for identifying the plurality of events.

8. The computer program product of claim 1, wherein the data structure includes a hierarchical data structure.

9. The computer program product of claim 1, wherein the objects are at least one of accessed, created and modified via the plurality of events.

10. The computer program product of claim 1, wherein the objects include at least one of a network connection, a process, a thread” a file and a registry key.

11. The computer program product of claim 1, wherein relationships associated with the plurality of events include relationships between the plurality of events and the objects.

12. The computer program product of claim 11, wherein each of the relationships associated with the plurality of events indicate an action performed with respect to one of the objects via one of the plurality of events.

13. The computer program product of claim 11, wherein the relationship associated with the plurality of events include creation of one of the objects by one of the plurality of events.

14. The computer program product of claim 1, the operations further comprising storing a state of each of the objects in the data structure.

15. The computer program product of claim 14, wherein the state includes at least one of suspicious, innocent and detected.

16. The computer program product of claim 1, wherein the unwanted activity is detected by performing a behavioral analysis of the data structure.

17. The computer program product of claim 1, the operations further comprising repairing effects of the unwanted activity utilizing the data structure.

18. The computer program product of claim 1, wherein the events include activities and identifying the events includes detecting the activities as indicative of an unwanted behavior pattern.

19. A method, comprising:
identifying a plurality of events;
generating a data structure including objects associated with the plurality of events; and
detecting unwanted activity utilizing the data structure, wherein the plurality of events includes events predetermined to be of interest, which includes termination of a security application on a computer, and events originating from a predetermined electronic source associated with unwanted activity.

20. A system, comprising:
a processor configured for:
identifying a plurality of events,
generating a data structure including objects associated with the plurality of events, and
detecting unwanted activity utilizing the data structure, wherein the plurality of events includes events predetermined to be of interest, which includes termination of a security application, and events originating from a predetermined source associated with unwanted activity.

21. The system of claim 20, wherein the processor is coupled to memory via a bus.
